(19) United States
(12) Patent Application Publication
(10) Pub. No.: US 2006/0061824 A1
(43) Pub. Date: Mar. 23, 2006

(54) Print system and print control program

(75) Inventor: Yukiya Miyachi, Asaka-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/230,560

(22) Filed: Sep. 21, 2005

(30) Foreign Application Priority Data
Sep. 21, 2004 (JP) 2004-273925

(51) Int. Cl. G06K 15/00

(52) U.S. Cl. 358/1.18

(57) ABSTRACT

The present invention provides a print system using a continuous paper as a print paper, comprising: an image input device which inputs an image; a display device which displays the image and a trimming frame; a trimming range designating device which designates an aspect ratio of the trimming frame, and relative positions and relative sizes between the image and the trimming frame; a print layout selecting device which selects either the first print layout being provided such that a short side of the image is aligned with a width of the continuous paper, or the second print layout being provided such that a long side of the image is aligned with the width of the continuous paper; and a printing device which prints the image on the continuous paper based on the print layout having been selected by the print layout selecting device.

### BACKGROUND OF THE INVENTION

1. Field of the Invention

The present invention relates to a print system and a print control program, and particularly relates to a print system using a continuous paper (a roll of paper) as a print paper and a print control program.

2. Related Art

Generally, print papers cut in predetermined sizes are used in print systems. A print price is determined beforehand for each print of each print size. A total print price is calculated according to the number of prints and the sizes of the prints. For example, when an L-size (3.5″×5″) print costs 50 yen and a 2L-size (5″×7″) print costs 100 yen, ten L-size prints and two 2L-size prints come to 50×10+100×2=700 (yen) in total (not including a basic charge which may be added to the print price regardless of the number of prints). For example, a print output method disclosed in Japanese Patent Application Laid-Open No. 2001-265560 (paragraph [0011]) illustrates a price for each print of each different size, the number of prints, and the total print price as print charging information when images are outputted as prints.

### SUMMARY OF THE INVENTION

In recent years, print systems using continuous papers (rolls of paper) as print papers have become widespread. The print systems using rolls of paper as print papers have high flexibility in the longitudinal direction of the rolls of paper.

However, in the conventional print systems, print sizes are determined beforehand and thus it is not possible to take full advantage of the flexibility in the longitudinal direction of the rolls of paper.

The present invention is devised in view of these circumstances and has as its object the provision of a print system and a print control program which can provide prints with high flexibility in print size.

In order to attain the object, a print system according to a first aspect of the present invention is a print system using a continuous paper as a print paper, comprising an image input device which inputs an image, a display device which display the image and a trimming frame, a trimming range designating device which designates an aspect ratio of the trimming frame and relative positions and relative sizes between the image and the trimming frame, a print layout selecting device which selects one of a first print layout and a second print layout, the first print layout being provided for printing the image such that a short side of the image having been trimmed with a designated trimming range is aligned with a width of the continuous paper, the second print layout being provided for printing the trimmed image such that a long side of the image is aligned with the width of the continuous paper, and a printing device which prints the image on the continuous paper based on the print layout having been selected by the print layout selecting device.

With the print system of the first aspect, by using the flexibility in the longitudinal direction of the continuous paper, it is possible to provide prints with high flexibility in print size without restrictions of the size of the print paper or an aspect ratio.

A print system according to a second aspect of the present invention further comprises a charging device which charges a print price by calculating the print price based on at least one of an amount of use of the continuous paper, a print area on the continuous paper, and an amount of ink usage, and the display device to display the print price.

With the print system of the second aspect, in addition to a high degree of flexibility in print size, simple price setting can also be obtained, thereby increasing user satisfaction.

A print control program according to a third aspect of the present invention is a program for controlling the printing of a print system using a continuous paper as a print paper, the program causing a computer to perform a function of inputting an image, a function of displaying the image and a trimming frame, a function of designating an aspect ratio of the trimming frame and the relative positions and sizes of the image and the trimming frame, a function of selecting one of a first print layout and a second print layout, the first print layout being provided for printing the image such that a short side of the image having been trimmed with a designated trimming range is aligned with the width of the continuous paper, the second print layout being provided for printing the trimmed image such that a long side of the image is aligned with the width of the continuous paper, and a function of printing the image on the continuous paper based on the selected print layout.

According to the present invention, by using the flexibility in the longitudinal direction of the continuous paper, it is possible to provide prints with a high degree of flexibility in print size without restrictions of a prescribed paper size or an aspect ratio. Further, in the print system with a high degree of flexibility in print size, simple price setting is obtained, thereby increasing user satisfaction. Moreover, by scaling and cutting an image, the user can freely select only a desired part for printing, thereby reducing the cost of printing and increasing user satisfaction.

### BRIEF DESCRIPTION OF THE DRAWINGS

FIG. 1 is a block diagram showing a print system according to an embodiment of the present invention;

FIG. 2 is a diagram showing the main configuration of a printer 22;

FIG. 3 is a diagram showing an example of an operation screen displayed on a display 16 when a print order is placed;

FIG. 4 is a flowchart showing a printing method according to the embodiment of the present invention; and

FIGS. 5A and 5B are diagrams showing setting examples of a print layout of an image 48.

### DETAILED DESCRIPTION OF THE PREFERRED EMBODIMENTS

The following will describe a preferred embodiment of a print system and a print control program of the present invention in accordance with the accompanying drawings.

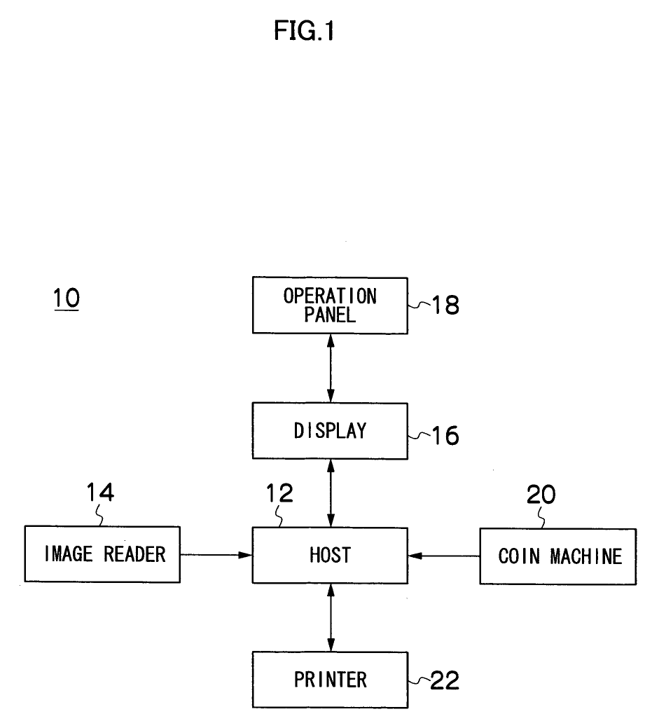

FIG. 1 is a block diagram showing the print system according to the embodiment of the present invention. As shown in FIG. 1, a print system 10 is applied to, e.g., a print system placed in a shop such as a minilab and a photo preprocessing shop and a self-terminal in a shop. The print system 10 comprises a host computer 12, an image reader 14, a display 16, an operation panel 18, a coin machine 20, and a printer 22.

The host computer 12 is a device exercising control over the parts of the print system 10.

The image reader 14 is a device which includes a media reader for reading images recorded on a recording medium (such as a memory card and a CD-R), an adapter, and a cable or the like which are connected to a digital camera, a camera phone, and so on to read an image.

The display 16 is a display for displaying various operation menus and images read by the image reader 14.

The operation panel 18 is a device for receiving an input from the user in response to a display or the like produced on the display 16. For example, the operation panel 18 is a touch panel provided on a surface of the display 16.

The coin machine 20 is a device for charging and payment of a print price based on the contents of a print instruction inputted from the operation panel 18.

The printer 22 is a device for printing images read by the image reader 14, based on the contents of the print instruction inputted from the operation panel 18.

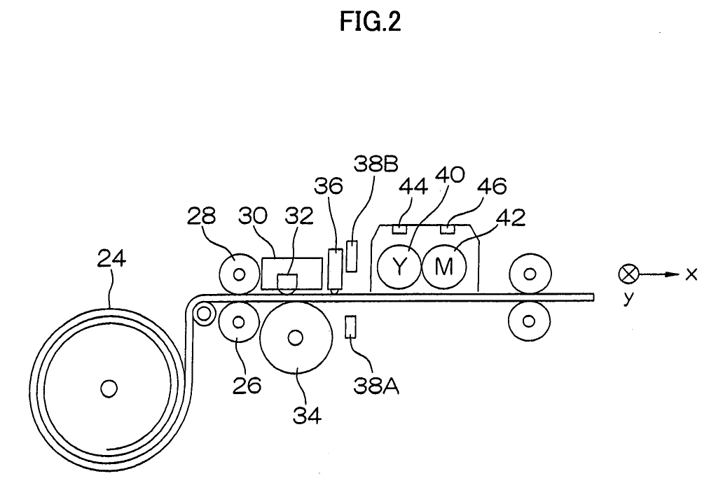

FIG. 2 is a diagram showing the main configuration of the printer 22. As shown in FIG. 2, the printer 22 of the present embodiment is a TA printer using a Thermo-Auto chrome (TA) paper 24, which is a continuous paper (a roll of paper), as a print paper.

Along a feed path for feeding the TA paper 24, from the left of FIG. 2, there are provided a capstan roller 26, a nip roller 28, a thermal head 30, a sensor 32 for detecting the temperature of the thermal head 30, a platen roller 34, a cutter 36, an LED 38A and a light-receiving sensor 38B which constitute an HP sensor 38, a Y-fixing fluorescent lamp 40, an M-fixing fluorescent lamp 42, a sensor 44 for measuring the illuminance of the Y-fixing fluorescent lamp 40, and a sensor 46 for measuring the illuminance of the M-fixing fluorescent lamp 42.

The TA paper 24 fed from the upstream side (the left in FIG. 2) of the feed path is interposed between the capstan roller 26 and the nip roller 28 and interposed between the thermal head 30 and the platen roller 34. During printing, the capstan roller 26 is rotated by a motor, so that the TA paper 24 reciprocates in a sub-scanning direction indicated as x direction in FIG. 2.

On the thermal head 30, a plurality of heating elements are arranged like lines in a main scanning direction (y direction in FIG. 2) perpendicular to the sub-scanning direction (x direction in FIG. 2) which is the feeding direction of the TA paper 24. When the TA paper 24 is carried in a printing direction indicated as x direction, a predetermined heat is applied to the TA paper 24 for each line in the main scanning direction to develop the colors of color layers.

The LED 38A of the HP sensor 38 emits light to the light-receiving sensor 38B across the feed path of the TA paper 24. The presence or absence of the TA paper 24 can be detected based on a detection signal of the light-receiving sensor 38B. The detection signal outputted from the light-receiving sensor 38B is inputted to a system controller through an AD converter (not shown).

By detecting whether light emitted from the LED 38A is received by the light-receiving sensor 38B, the system controller decides whether the TA paper 24 is thus present on the position of the HP sensor 38. By detecting a change between the presence and absence of the TA paper 24 on the position of the HP sensor 38, it is detected whether the end of the TA paper 24 has been carried to the position of the HP sensor 38. The TA paper 24 is thus positioned relative to the home position which is set when the end of the TA paper 24 is carried to the position of the HP sensor 38. Relative to this position, the TA paper 24 is carried and printing including coloring and fixation is performed in a synchronous manner.

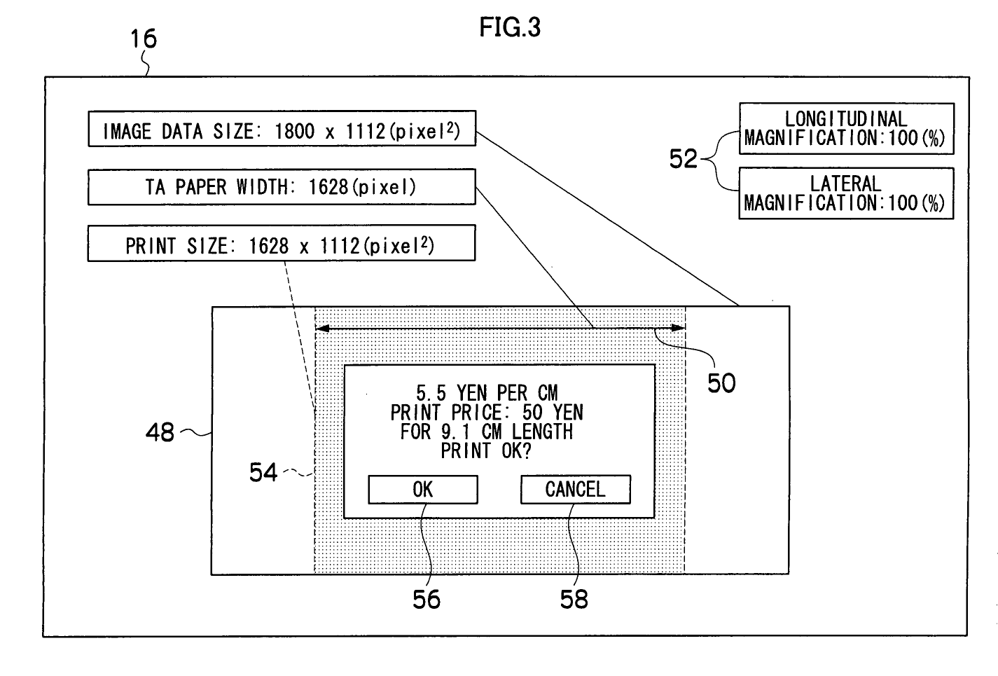

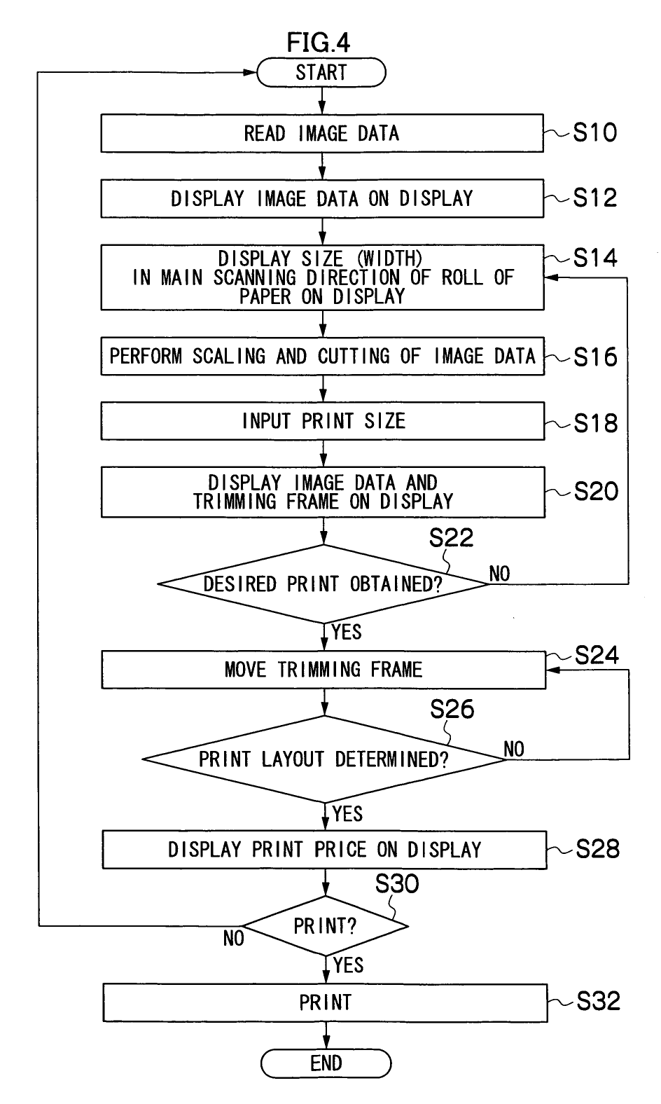

Referring to FIGS. 3 and 4, the following will discuss a printing method in the print system 10. FIG. 3 is a diagram showing an example of an operation screen displayed on the display 16 when a print order is placed. FIG. 4 is a flowchart showing the printing method according to the embodiment of the present invention.

First, when an image is read by the image reader 14 (step S10), a read image 48 is displayed on the display 16 (step S12). Then, as shown in FIG. 3, a size (width) in the main scanning direction of the TA paper 24 is displayed on the display 16 (step S14). In the example of FIG. 3, the numeric value of the number of pixels indicating the size in the main scanning direction of the TA paper 24 and an arrow 50 are displayed on the same scale as the image 48.

Then, a longitudinal magnification 52 and a lateral magnification 52 are operated on the operation panel 18 to perform operations such as scaling, cutting, and rotation of the image 48 (step S16). When a print size is inputted (step S18), a trimming frame 54 corresponding to the inputted print size is displayed on the display 16 on the same scale as the image 48 and the arrow 50 (step S20). As shown in FIG. 3, the width of the trimming frame 54 is limited to the size (width) in the main scanning direction of the TA paper 24.

Subsequently, based on the relative sizes and so on of the image 48 and the trimming frame 54, it is decided whether a desired print can be obtained with the print size having been inputted in step S18 (step S22). In step S22, when it is decided that the desired print cannot be obtained with the current print size, the process returns to step S14. On the other hand, when it is decided that the desired print can be obtained with the current print size, the trimming frame 54 is moved by the operation panel 18 and a print layout is changed such that a part to be printed in the image 48 (trimming range) is placed in the trimming frame 54 (step S24). In step S24, the print size can be set as follows: one of a long side and a short side of the trimming frame 54 is selected to be aligned with the size (width) in the main scanning direction of the TA paper 24.

Then, when the position of the trimming frame 54 (trimming range) is determined and a print layout is determined (step S26), a print price is calculated by the host computer 12 according to the length of the TA paper 24 required for printing, and the print price is displayed on the display 16 (step S28). In the example of FIG. 3, the TA paper 24 costs 5.5 yen per centimeter in length and the used TA paper 24 is 9.1 cm, so that a print price of 50 yen is displayed.

In the present embodiment, a print price is calculated according to the length of the used TA paper 24. A print price may be calculated according to a print area (e.g., 0.5 yen per square centimeter) and so on. When ink is used for printing, a print price may be calculated according to the amount of ink usage.

When an “OK” button 56 is touched in step S30, the trimming range (a shaded part in FIG. 3) having been determined in step S26 is printed (step S32). When a “cancel” button 58 is touched, printing is cancelled (returns to start).

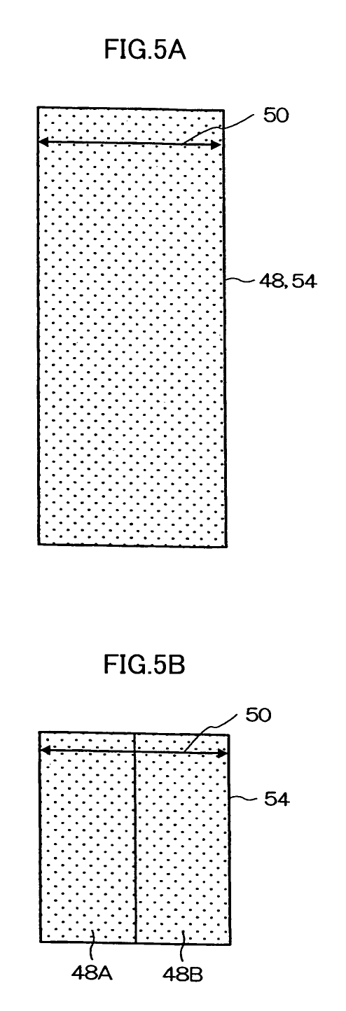

Referring to FIGS. 5A and 5B, the following will discuss another setting example of a print layout. FIGS. 5A and 5B are diagrams showing setting examples of a print layout of the image 48.

FIG. 5A shows an example in which the image 48 is enlarged such that the short side of the trimming range of the image 48 is aligned with the size (width) in the main scanning direction of the TA paper 24. When the image 48 with a small size (number of pixels) is enlarged, the interpolation of pixels may be performed (linear interpolation, etc.). The upper limit value of a magnification may be set beforehand according to the number of pixels. When the image 48 is made larger than the upper limit value, a warning may be issued or the image 48 may be prohibited enlargement to the upper limit value or larger.

As shown in FIG. 5B, when a long image is printed, the orientation of the image 48 may be changed to arrange two or more images 48A and 48B, and the sum of the short sides of the images 48A and 48B may be made equal to the size (width) in the main scanning direction of the TA paper 24. In this case, the cutter 36 in FIG. 2 is caused to scan in the sub-scanning direction (the longitudinal direction of the TA paper 24), so that the images 48A and 48B can be separated from each other.

According to the present embodiment, the trimming range can be arbitrarily set without restrictions of a prescribed size or an aspect ratio of the image 48 and a print paper. Further, by aligning any one of the long side and the short side of the trimming range with the width of the TA paper 24, a print layout can be set with high flexibility.

In the present embodiment, the TA printer is used in which a print paper is a roll of paper. The present invention is not limited to a print system using a TA printer. The present invention is applicable to any print system as long as a continuous paper (a roll of paper) is used as a print paper.

What is claimed is:

1. A print system using a continuous paper as a print paper, comprising:
an image input device which inputs an image;
a display device which displays the image and a trimming frame;
a trimming range designating device which designates an aspect ratio of the trimming frame and designates relative positions and relative sizes between the image and the trimming frame;
a print layout selecting device which selects one of a first print layout and a second print layout, the first print layout being provided for printing the image such that a short side of the image having been trimmed with a designated trimming range is aligned with a width of the continuous paper, the second print layout being provided for printing the trimmed image such that a long side of the image is aligned with the width of the continuous paper; and
a printing device which prints the image on the continuous paper based on the print layout having been selected by the print layout selecting device.

2. The print system according to claim 1, further comprising:
a charging device which charges a print price by calculating the print price based on at least one of an amount of use of the continuous paper, a print area on the continuous paper, and an amount of ink usage; and
the display device to display the print price.

3. A print control program for controlling printing of a print system using a continuous paper as a print paper, the program causing a computer to perform:
a function of inputting an image;
a function of displaying the image and a trimming frame;
a function of designating an aspect ratio of the trimming frame and designating relative positions and relative sizes between the image and the trimming frame;
a function of selecting one of a first print layout and a second print layout, the first print layout being provided for printing the image such that a short side of the image having been trimmed with a designated trimming range is aligned with a width of the continuous paper, the second print layout being provided for printing the trimmed image such that a long side of the image is aligned with the width of the continuous paper; and
a function of printing the image on the continuous paper based on the selected print layout.
